(19) United States
(12) Patent Application Publication
(10) Pub. No.: US 2024/0390824 A1
(43) Pub. Date: Nov. 28, 2024

(54) MACHINE SYSTEM WITH FILTER PRESS AND REMOVAL DEVICE

(71) Applicant: STRASSBURGER FILTER GMBH + CO. KG, Westhofen (DE)

(72) Inventor: Dominik DUCKGEISCHEL, Bechtolsheim (DE)

(21) Appl. No.: 18/667,165

(22) Filed: May 17, 2024

(30) Foreign Application Priority Data
May 22, 2023 (DE) 102023113327.6

(51) Int. Cl. B01D 25/21

(52) U.S. Cl. CPC B01D 25/21; B01D 2201/0415

(57) ABSTRACT

Machine system having a filter press and a removal device, wherein the filter press has a frame and a plurality of plates, wherein the plates are arranged one behind the other in the frame along a main axis H of the filter press, wherein the filter press defines an installation space which completely accommodates at least the frame and the plates and has vertical side surfaces, and wherein the removal device is configured for removing plates from the frame. The removal device is arranged predominantly laterally outside the installation space.

The present invention relates to a machine system with a filter press and a removal device.

Filter presses are used for filtering liquids. During filtration, particles are removed from the liquid. The aim is always a particularly pure filtrate which, apart from the desired liquid and any desired particles, does not contain any other, undesired particles. Filtered liquids include beverages such as juice or wine as well as pharmaceutical liquids such as blood plasma.

A filter press known from EP 3 400 997 A1 comprises a frame and a plurality of plates, the plates being arranged one behind the other in the frame along a main axis H of the filter press. The plates must be cleaned from time to time. For this purpose, the plates are removed individually from the filter press and transferred to a washing device. Removal devices are provided in the prior art for this purpose. One such removal device comprises a rail-guided gripper that is mounted directly above the filter press on the ceiling of the room. The gripper removes the plates individually upwards and transports them to a washing device. After washing, the gripper transports the plate back to its position in the filter press.

A filtering apparatus is known from EP 0 499 589 A1, in which gas exchange between the place where the cleaning of the plates occurs and the environment, in particular the filter press containing already cleaned filter plates, is largely prevented or at least reduced to a level that is harmless according to the application.

Particularly high demands are placed on the purity of the filtrate, especially when filtering pharmaceutical liquids. The object of the invention was therefore to reduce the probability of contamination of filter presses.

This object is solved by a machine system according to claim 1.

The machine system comprises a filter press and a removal device. The filter press has a frame and a plurality of plates. The plates are arranged one behind the other in the frame along a main axis H of the filter press. The filter press defines an installation space that completely accommodates at least the frame and the plates and has vertical side surfaces. The removal device is configured to remove plates from the rack. The machine system is characterized in that the removal device is arranged predominantly laterally outside the installation space. In other words, the removal device is arranged predominantly outside the installation space, namely laterally, i.e. in particular not above or below the installation space or above or below the filter press.

The main axis H preferably runs horizontally.

The term “lateral” refers in particular to directions in a horizontal direction.

It has been recognized that unwanted particles can enter the filtrate in two ways. Firstly, it is conceivable that the particles were already contained in the liquid to be filtered and were not filtered out by the filter press. On the other hand, particles can also enter the filter press during breaks between filtering processes and enter the filtrate during a subsequent filtering process. It has been shown that extraction devices known from the prior art are a source of unwanted particles. One of the reasons for this is abrasion in the bearings of the extraction device. In order to prevent particles from the removal device getting into the filtrate, the removal device in the system according to the invention is arranged laterally outside the area directly above the filter press. Particles that detach from the removal device essentially fall downwards due to gravity. Due to the arrangement of the removal device according to the invention, these particles fall next to and not onto the filter press or its essential components. In this way, the particles are prevented from entering the filter press, the filtrate and/or the liquid to be filtered. This improves the purity of the filtrate.

The installation space preferably accommodates all components of the filter press with the exception of feed lines. The components of a filter press include, in particular, crossbars, support rods, feet and the like. The installation space is preferably unlimited at the top, i.e. open at the top. The removal device is therefore not arranged above the filter press, or only to a small extent. The installation space preferably has only vertical side surfaces. The installation space preferably has the shape of a vertical cylinder with a polygonal base (prism), in particular with a rectangular base. If the machine system is arranged in a room, for example a hall or a laboratory, the installation space preferably extends vertically from the floor to the ceiling of the room.

The plates can be frame plates, membrane plates and/or filter plates. Together, the plates form a plate pack.

The removal device can assume several different positions, in particular one or more handling positions, one or more rest positions and/or one or more transfer positions. In a rest position, the removal device does not interact with the filter press. A rest position is in particular a position in which the removal device does not interact with any other object. In a handling position, the removal device interacts with a plate of the filter press; in particular, a temporary connection between the removal device and the plate is present in the handling position, for example because the removal device holds a plate. In a transfer position, the removal device can transfer a removed plate to another part of the machine system, for example to a cleaning device. It is particularly advantageous if the removal device is arranged completely laterally outside the installation space in at least one of its positions, in particular in the rest position and/or the transfer position.

In advantageous embodiments, the removal device has a support and a gripping device mounted on the support, wherein the gripping device is configured for gripping individual or multiple plates. The gripping takes place by means of a temporary connection between the gripping device and the plate(s). The temporary connections include, in particular, mechanical connections (force fit and/or form fit), pneumatic connections (vacuum technology, suction cup) and magnetic connections.

The gripping device is preferably movable, in particular the removal device assumes different positions by moving the gripping device from one position to another. The gripping device is preferably configured to assume at least one position in which it faces the filter press and at least one position in which it faces away from the filter press. The gripping device can also be configured to assume a position facing a cleaning device.

The support is preferably arranged completely outside the installation space. This arrangement helps to ensure that few or no particles can enter the filter press from the support and also from points of contact between the support and the gripping device. The support is preferably immovable in itself, i.e. it cannot assume different positions, particularly within the removal device.

In some advantageous embodiments, the support is suitable for being mounted on a ceiling, a wall and/or a floor. This allows the support to be arranged next to the filter press in a fixed, unchangeable location. All movements of the removal device, i.e. in particular transitions between the positions of the removal device, are then preferably carried out by the gripping device. The unchangeable arrangement of the support simplifies the control of the gripping device.

In other advantageous embodiments, the support is mounted on an industrial truck, in particular a driverless transport vehicle. An industrial truck is understood in particular to be a vehicle that travels on level ground and has its own traction drive. Rail-bound vehicles and vehicles suspended from a ceiling or from a support (e.g. cranes) are in particular not covered by the term industrial truck. Attaching the support to an industrial truck offers particularly great flexibility when removing the plates from the rack. The support and with it the gripping device can thus be moved to different locations next to the filter press. The industrial truck can therefore take over some of the movements of the removal device. Due to this, the gripping device can be designed to be particularly compact, for example, as it no longer has to perform all the movements. A driverless transport vehicle is understood in particular to be an industrial truck that is configured to be automatically controlled and guided without contact. In addition, the industrial truck can be controlled in such a way that it does not protrude into the installation space at any point in time. This prevents particles from the industrial truck from entering the filter press.

The driverless transport vehicle is preferably configured to temporarily carry one or more plates. For this purpose, the driverless transport vehicle preferably has a storage surface and/or a plate holder. In this way, it is possible for several plates to be removed from the rack one after the other or simultaneously by the removal device and then temporarily stored on the automated guided vehicle. The industrial truck can then drive with the plates to the cleaning device, where the plates are again arranged individually or in groups by the removal device in the cleaning basin. This saves travel time for the industrial truck. The overall cleaning process is therefore shorter, which means that the filter press has less downtime. Alternatively, the time saved can be invested in more thorough cleaning. In this way, the cleaning result is improved.

The removal device preferably has a removal control unit. The removal control unit is preferably configured to receive signals relating to the movement of the industrial truck and/or the gripping device from a central control device of the machine system and to transmit the signals to the industrial truck and/or the gripping device.

In advantageous embodiments, it is provided that the support comprises at least one rail and that the gripping device comprises a carriage movable on the at least one rail. The gripping device can move relative to the rail by means of the carriage. In this way, the gripping device can perform some or all of the movements of the removal device. The rail or at least a section of the rail that can be moved by the carriage is preferably arranged completely outside the installation space. This prevents particles from the rail and, in particular, abrasion between the rail and carriage from entering the filter press.

The rail can either be mounted in a fixed location or on the industrial truck. If the rail is mounted in a fixed location, the gripping device performs all movements of the removal device. If the rail is arranged on the industrial truck, the movements of the removal device are carried out by the gripping device and the industrial truck.

The rail preferably runs parallel to the main axis of the filter press. Furthermore, the rail extends over the entire area in which the plates are arranged in the filter press. In this way, the gripping device can be brought into close proximity to each of the plates to be removed.

The gripping device preferably comprises an articulated arm robot with a gripping unit. In particular, an articulated arm robot is understood to be a multi-axis robot. An articulated arm robot produces little abrasion during operation, which largely prevents contamination of the filter press. In addition, an articulated arm robot is well suited for reaching the plates arranged along the main axis H.

The articulated arm robot is preferably mounted on the carriage or the industrial truck, in particular by means of the support. In this way, the movements of the removal device are carried out by the carriage and the articulated arm robot or by the industrial truck and the articulated arm robot. This allows the articulated arm robot to be more compact, as it does not have to reach plates over the entire length of the filter press. Instead, the articulated arm robot can be brought close to the plate to be removed by means of the carriage or the industrial truck and then carry out the actual removal operation there.

The gripping device only interacts with the filter press when plates are to be removed from the filter press and inserted into the filter press. During the filtration process, the gripping device does not interact with the filter press. It was recognized that in these phases, the entry of particles into the filter press can be largely prevented by completely removing the gripping device from the filter press. In a state facing away from the filter press, the gripping device is therefore preferably arranged completely outside the installation space. Particularly preferably, the removal device is arranged completely outside the installation space when the gripping device is in a position facing away from the filter press. This largely prevents particles from the removal device entering the filter press during the filtration process, for example.

The plates can be removed from the filter press for various reasons. Most frequently, the plates are removed in order to be subjected to cleaning. The machine system preferably has a cleaning device for plates that is arranged predominantly outside the installation space, in particular in a vertical projection.

A vertical projection is understood to be an image of three-dimensional objects on a two-dimensional, horizontal plane. A vertical projection is therefore present, for example, in a top view. The assessment of whether an object in vertical projection is arranged predominantly outside the installation space is based on the areas in the two-dimensional, projected plane. If more than half (50%) of the surface of the object is outside the area of the installation space, the object is predominantly outside the installation space. Preferably, >70% of the surface of the object and particularly preferably >90% of the surface of the object is outside the installation space. The larger the proportion that is outside the installation space, the lower the probability of particles being introduced from the respective object.

The objects whose position relative to the installation space in vertical projection can be considered in the context of the invention include, in particular, the removal device, the gripping device, the support, the rail and the cleaning device. The removal device in particular is preferably arranged in a vertical projection predominantly laterally outside the installation space.

The cleaning device preferably comprises a cleaning basin that is open at the top and can optionally be closed by a cover. Preferably, cleaning nozzles are arranged in the cleaning basin, which can eject a cleaning liquid under high pressure. The plates are arranged in the cleaning basin for cleaning. The cleaning basin can then optionally be closed by the cover. Cleaning fluid is then fed through the cleaning nozzles. The cleaning fluid is then ejected under high pressure and hits the plates. This cleans the plates efficiently. The cleaning fluid is collected in the cleaning basin, from where it is drained off and optionally treated.

The removal device can be configured to transport one or more plates from the filter press directly to the cleaning device and back. Alternatively, the plates can also be removed from the removal device and temporarily stored at a predetermined location. A plate holder can be provided at the location in which the plates can be temporarily stored. From this location, the plates can then be transferred to the cleaning device by another apparatus, for example another articulated arm robot. Direct transport from the filter press to the cleaning device by the removal device is preferable, as the complexity of the machine system is lower in this case.

The less movement the removal device has to perform when removing the plates and transferring them to the cleaning device, the fewer particles end up in the filter press. The support of the removal device or the removal device as a whole is therefore preferably arranged between the filter press and the cleaning device, in particular in a vertical projection. This applies in particular to cases in which the removal device is arranged in a fixed, unchangeable location.

The machine system can have one or more control units. In particular, the filter press, the removal device and the cleaning device can have one or more control units. In addition, the machine system can have a central control device that is connected to the control units. The machine system preferably comprises a control console, which is preferably located outside the installation space.

The driverless transport vehicle can also operate at least partially autonomously. In advantageous embodiments, the filter press and/or the cleaning device have one or more reference points for the driverless transport vehicle and the driverless transport vehicle comprises a vehicle control unit that is configured to detect reference points. For detection, the driverless transport vehicle can, for example, have an optical system, in particular a camera.

The invention is illustrated and explained below by way of example with reference to the drawings. Shown are:

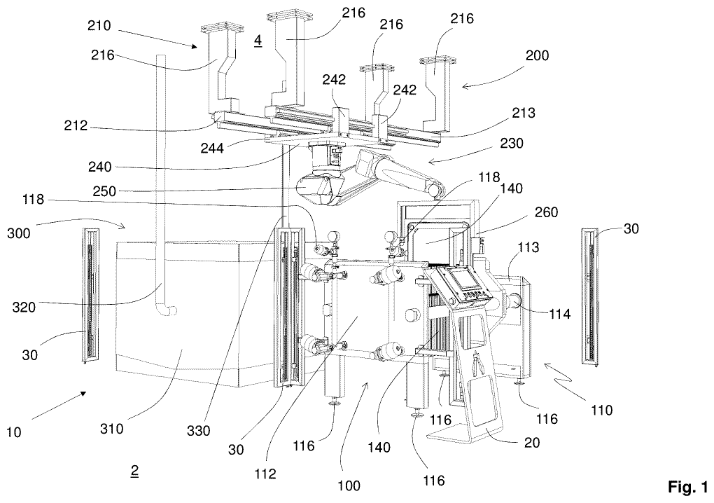

FIG. 1 is a perspective view of a machine system according to the invention

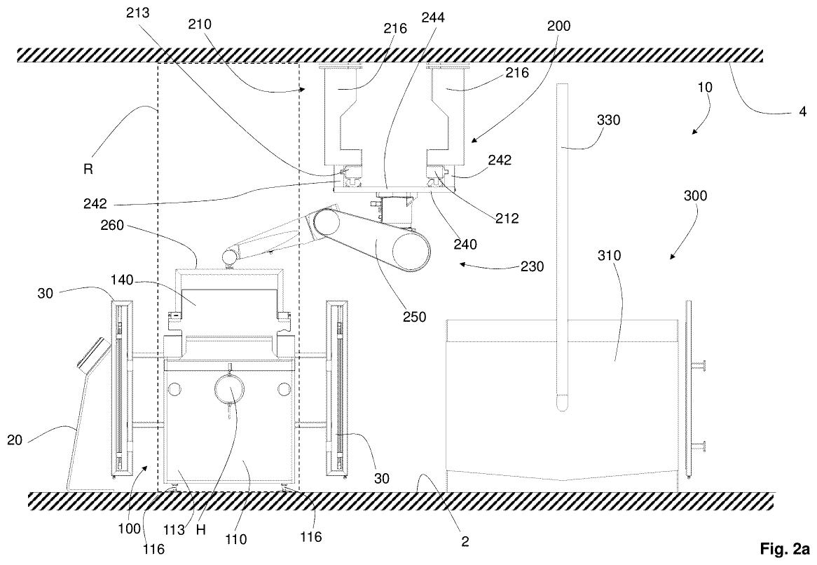

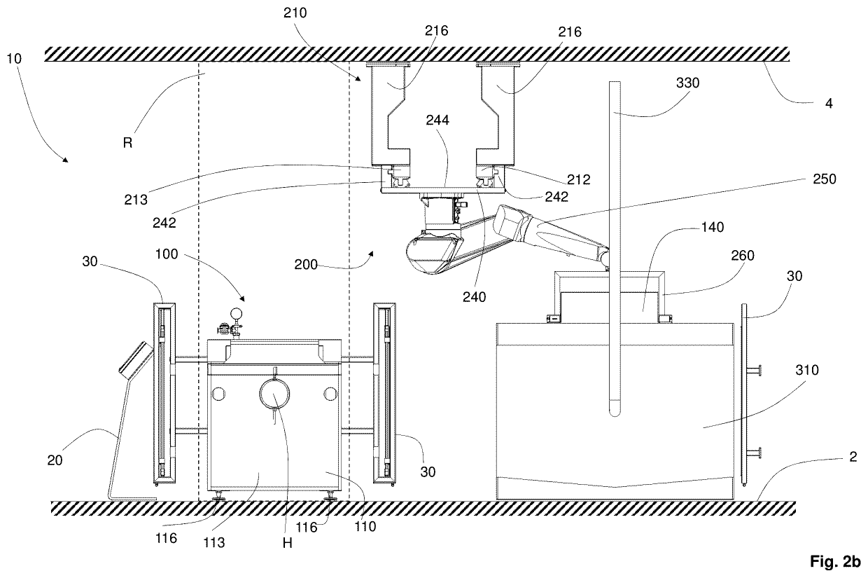

FIG. 2a a side view of the machine system of FIG. 1 in a first state

FIG. 2b a side view of the machine system of FIG. 1 in a second state

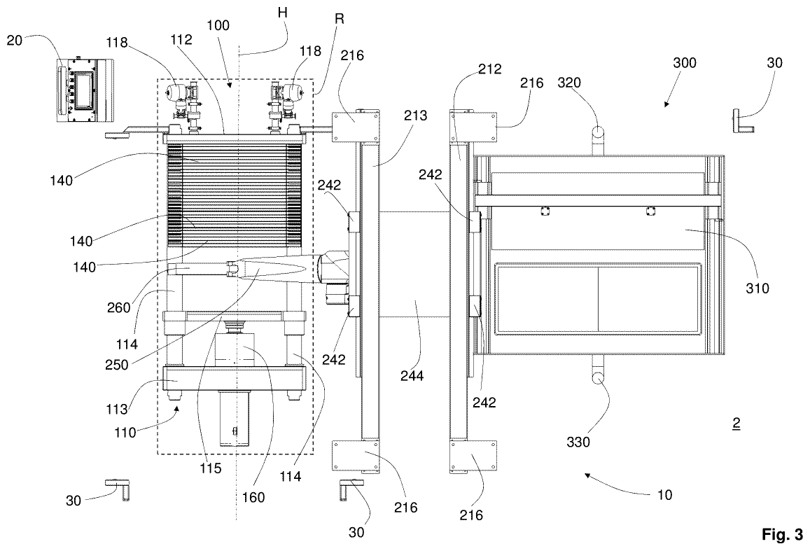

FIG. 3 Top view of the machine system of FIG. 1

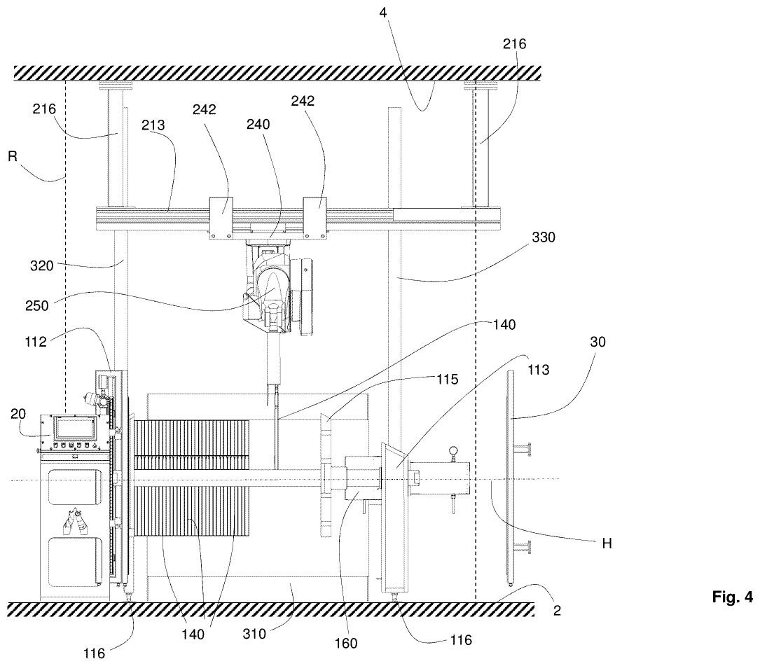

FIG. 4 front view of the machine system of FIG. 1

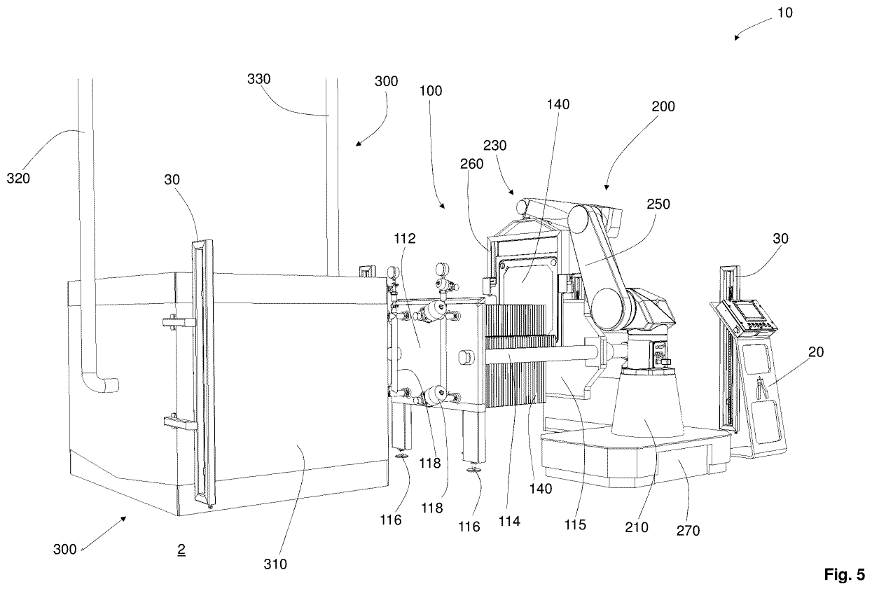

FIG. 5 a further embodiment of a machine system according to the invention in a perspective view in a first state

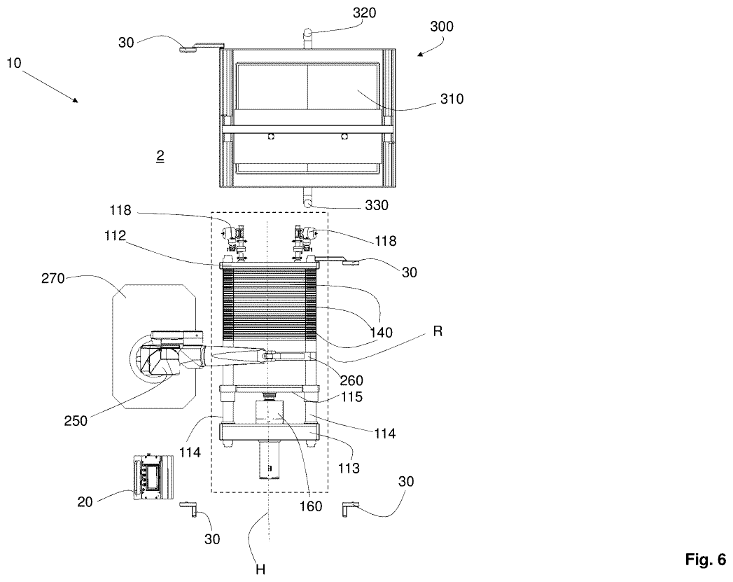

FIG. 6 top view of the machine system of FIG. 5

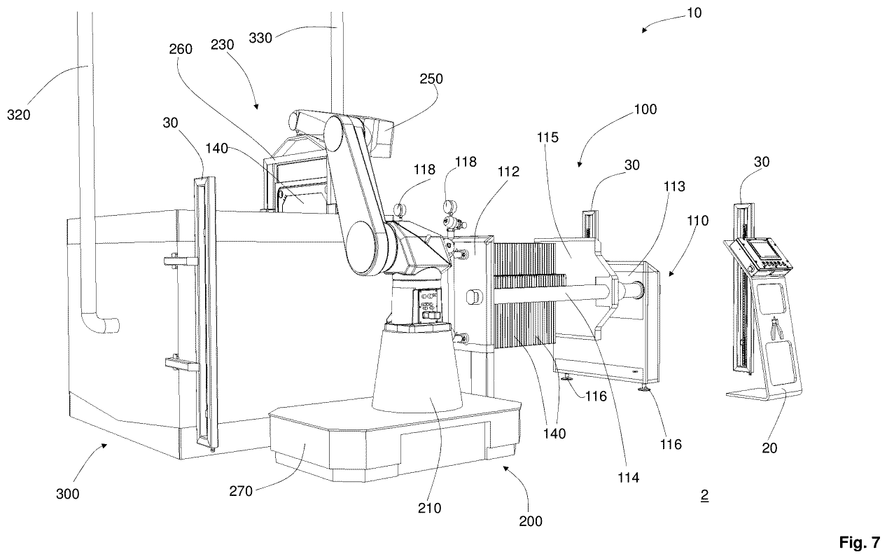

FIG. 7 a perspective view of the machine system of FIG. 5 in a second state

The machine system 10 shown in FIGS. 1 to 4 comprises a filter press 100, a removal device 200 and a cleaning device 300. FIG. 3 shows a vertical projection (top view) of the machine system 10.

The machine system 10 is arranged in a room which has a floor 2 and a ceiling 4. The filter press 100 stands on the floor 2.

The filter press 100 has a frame 110 and a plurality of plates 140. The frame 110 comprises two frame plates 112, 113 at two opposite ends and a pressing plate 115 arranged between the frame plates 112, 113. The frame plates 112, 113 and the pressing plate 115 are connected to one another via two support beams 114. The frame plates 112, 113 run vertically and are each connected to two feet 116, which stand on the floor 2. Together with the one frame plate 112, the pressing plate 115 delimits a receiving space for the plates 140. The support beams 114 run parallel to each other.

A main axis H of the filter press runs from the first frame plate 112 to the second frame plate 113 and parallel to the support beams 114. The main axis H and the support beams 114 run horizontally. The plates 140 rest one behind the other along the main axis H in the receiving space on the support beams 114 and are thereby arranged one behind the other along the main axis H in the frame 110.

The first rack plate 112 comprises a plurality of ports 118, through which the liquid to be filtered is directed to the plates 140 and the filtered liquid (the filtrate) is drained from the plates 140.

The pressing plate 115 is arranged to slide on the support beams 114 along the main axis H.

The filter press 100 comprises a pressing device 160, by means of which the pressing plate 115 is moved in the direction of the first support plate 112. As a result, the plates 140 are pressed together along the main axis H when used as intended. In the compressed state, the plates 140 seal against each other. Subsequently, the liquid to be filtered can be passed through the plates 140, whereby it is filtered. Before the plates 140 are removed, the pressing plate 115 is moved in the direction of the second frame plate 113. This reduces the pressure on the plates 140 so that they can be easily removed.

The filter press 100 defines an installation space R. In the embodiment shown, the installation space R completely accommodates the frame 110 and the plates 140. The installation space R has a rectangular basic shape (see FIG. 3) and vertical side surfaces (see FIGS. 2a, 2b, 4), which are indicated by dashed lines in the drawings. In the vertical direction, the installation space R extends from the floor 2 to the ceiling 4.

The removal device 200 comprises a support 210 with two rails 212, 213. The two rails 212 are each mounted on the ceiling 4 by means of two holders 216. The rails 212, 213 run parallel to the main axis H of the filter press 100. Furthermore, the rails 212, 213 run completely outside the installation space R (see FIG. 3).

The removal device 200 further comprises a gripping device 230 with a carriage 240. The carriage 240 is guided linearly by the rails 212, 213 and is movable along the rails 212, 213. The carriage 240 comprises four running units 242, two of which are guided by each of the two rails 212, 213, and a mounting plate 244. The mounting plate 244 is fixedly connected to the four running units 242.

The gripping device 230 further comprises an articulated arm robot 250, here a six-axis industrial robot, and a gripping unit 260. The articulated arm robot 250 is mounted on the mounting plate 244 and can thus be moved along the rails 212, 213. The gripping unit 260 is configured to grip a plate 140, i.e. to establish a temporary connection with the plate 140. Once this has been done, the gripping unit 260 can be lifted upwards out of the frame 110 by means of the articulated arm robot 250 (see FIG. 1). As a result, the removal device 200 is configured to remove plates 140 from the frame 110.

As can be seen from FIG. 3, the removal device 200 is arranged predominantly laterally outside the installation space R. The articulated arm robot 250 and the gripping unit 260 protrude into the installation space R when the gripping device 230 is in a position facing the filter press 100, i.e. in particular when a plate 140 is removed from the frame 110 (FIG. 2a). If the gripping device 230 is in a position facing away from the filter press 100, the gripping device 230 is completely outside the receiving space R (FIG. 2b). The rails 212, 213 and the carriage 240 are not arranged in any position within the receiving space R.

The cleaning device 300 comprises a cleaning basin 310 with a supply line 320 and a discharge line 330. The cleaning basin 310 is cube-shaped. In the embodiment of FIG. 3, the cleaning basin 310 is open at the top. In this state, the cleaning basin 310 can be loaded with plates 140. Subsequently, the cleaning basin 310 is closed by a cover (not shown) and the plates 140 are subjected to a cleaning process. In the cleaning basin 310 there are cleaning nozzles (not visible), which eject a cleaning liquid under high pressure and thereby clean the plates 140. The cleaning fluid is directed to the cleaning nozzles by means of the supply line 320. By means of the discharge line 330, the ejected cleaning liquid is removed from the cleaning basin 310. In other embodiments, the plates 140 may also be immersed in a bath of cleaning liquid or in a continuous stream of cleaning liquid. The plates 140 removed from the rack 110 by the removal device 200 are arranged in the cleaning basin 310 by a movement of the articulated arm robot 250 and, if necessary, the carriage 240, where they are cleaned by means of the cleaning fluid. The plates 140 can then be returned to the frame 110.

The cleaning device 300 is arranged completely outside the installation space R.

The machine system 10 comprises a control console 20 for controlling the filter press 100, the removal device 200 and the cleaning device 300. The control console 20 is arranged outside the installation space R. The machine system 10 comprises several control units that are connected to the control console 20.

The machine system 10 comprises light barriers 30, which can be used to detect the presence of persons in the area around the filter press 100. The presence of people may be undesirable at certain times, particularly during the filtering process.

The machine system 10 shown in FIGS. 5 to 7 also comprises a filter press 100, a removal device 200 and a cleaning device 300. The filter press 100 and the cleaning device 300 are essentially identical to the same assemblies of the first embodiment (FIG. 1).

In this embodiment, the removal device 200 comprises a support 210 which is mounted on an industrial truck 270 in the form of a driverless transport vehicle. A gripping device 230 is mounted on the support 210. The gripping device 230 comprises an articulated arm robot 250, here a six-axis industrial robot, and a gripping unit 260. The gripping unit 260 is configured to grip a plate 140, i.e. to establish a temporary connection with the plate 140. Once this has been done, the gripping unit 260 can be lifted upwards out of the frame 110 by means of the articulated arm robot 250 (see FIG. 6). As a result, the removal device 200 is configured to remove plates 140 from the frame 110.

After a plate 140 has been removed, the gripping device 230 can be moved next to the cleaning basin 310 of the cleaning device 300 by means of the industrial truck 270 (see FIG. 7). There, the removed plate 140 can be arranged by the gripping device 230 in the cleaning basin 310, where it is cleaned.

It is further possible that several plates 140 are removed from the rack 110 one after the other or simultaneously by the removal device 200 and are then temporarily stored on the industrial truck 270. Subsequently, the industrial truck 270 can travel with the plates 140 to the cleaning device 300, where the plates 140 are again arranged individually or in multiples by the removal device 200 in the cleaning basin 310. In this way, travel time of the industrial truck 270 is saved.

Subsequently, the plate 140 is again removed from the cleaning basin 310 by means of the gripping device 230. The industrial truck 270 then moves next to the filter press 100, whereupon the cleaned plate 140 can be placed back into the frame 110 by the gripping device 230. The gripping device 230 can then grip the next plate(s) 140, remove it from the rack 110 and feed it to the cleaning device 300.

### LIST OF REFERENCE SIGNS

2 Floor
4 Ceiling
10 Machine system
20 Control console
30 Light barrier
100 Filter press
110 Frame
112 First frame plate
113 Second frame plate
114 Support beam
115 Pressing plate
116 Base
118 Connection
140 Plate
160 Pressing device
200 Removal device
210 Support
212 Rai
213 Rail
216 Holder
230 Gripping device
240 Carriage
242 Running unit
244 Mounting plate
250 Articulated arm robot
260 Gripping unit
270 Industrial truck
300 Cleaning device
310 Cleaning basin
320 Supply line
330 Discharge line
H Main axis
R Installation space

What is claimed is:

1. A machine system, comprising:
a filter press and a removal device,
wherein the filter press comprises a frame and a plurality of plates,
wherein the plates are arranged one behind the other in the frame along a main axis of the filter press,
wherein the filter press defines an installation space which completely accommodates at least the frame and the plates and has vertical side surfaces,
wherein the removal device is configured to remove plates from the frame, and
wherein the removal device is arranged predominantly laterally outside the installation space (R).

2. The machine system according to claim 1, wherein the removal device can assume several different positions and is arranged completely laterally outside the installation space (R) in at least one position.

3. The machine system according to claim 1, wherein the removal device has a support and a gripping device mounted on the support, the gripping device being configured for gripping individual or several plates.

4. The machine system according to claim 3, wherein the support is arranged completely outside the installation space (R).

5. The machine system according to claim 3, wherein the support is suitable to be mounted on a ceiling, a wall and/or a floor.

6. The machine system according to claim 3, wherein the support is mounted on an industrial truck, in particular a driverless transport vehicle.

7. The machine system according to claim 3, wherein the support comprises at least one rail and in that the gripping device comprises a carriage movable on the at least one rail.

8. The machine system according to claim 7, wherein the rail or at least a section of the rail, which can be traversed by the carriage, is arranged completely outside the installation space (R).

9. The machine system according to claim 3, wherein the gripping device comprises an articulated arm robot with a gripping unit.

10. The machine system according to claim 9, wherein the articulated arm robot is mounted on the carriage or the industrial truck.

11. The machine system according to claim 3, wherein the gripping device is arranged completely outside the installation space (R) in a position facing away from the filter press.

12. The machine system according to claim 3, wherein the removal device is arranged completely outside the installation space (R) when the gripping device is in a position facing away from the filter press.

13. The machine system according to claim 1, wherein the machine system has a cleaning device for plates, which is arranged predominantly outside the installation space (R).

14. The machine system according to claim 13, wherein the removal device is configured to transport plates from the filter press to the cleaning device and back.

15. The machine system according to claim 13, wherein the support of the removal device or the removal device is arranged between the filter press and the cleaning device.

16. The machine system according to claim 6, wherein the filter press and/or the cleaning device has one or more reference points for the driverless transport vehicle and that the driverless transport vehicle comprises a vehicle control unit which is configured to detect reference points.

17. The machine system according to claim 2, wherein the removal device has a support and a gripping device mounted on the support, the gripping device being configured for gripping individual or several plates, and wherein the support is arranged completely outside the installation space (R).

18. The machine system according to claim 17, wherein the support is suitable to be mounted on a ceiling, a wall and/or a floor, or wherein the support is mounted on an industrial truck, in particular a driverless transport vehicle.

19. The machine system according to claim 18, wherein the support comprises at least one rail and in that the gripping device comprises a carriage movable on the at least one rail, wherein the rail or at least a section of the rail, which can be traversed by the carriage, is arranged completely outside the installation space (R), wherein the gripping device comprises an articulated arm robot with a gripping unit, and wherein the articulated arm robot is mounted on the carriage or the industrial truck.

20. The machine system according to claim 19, wherein the gripping device is arranged completely outside the installation space (R) in a position facing away from the filter press, wherein the removal device is arranged completely outside the installation space (R) when the gripping device is in a position facing away from the filter press, wherein the machine system has a cleaning device for plates, which is arranged predominantly outside the installation space (R), wherein the removal device is configured to transport plates from the filter press to the cleaning device and back, wherein the support of the removal device or the removal device is arranged between the filter press and the cleaning device, and wherein the filter press and/or the cleaning device has one or more reference points for the driverless transport vehicle and that the driverless transport vehicle comprises a vehicle control unit which is configured to detect reference points.
